(19) United States
(12) Patent Application Publication
(10) Pub. No.: US 2007/0048556 A1
(43) Pub. Date: Mar. 1, 2007

(54) Solid state detector for recording X-ray images

(76) Inventor: Martin Spahn, Chicago, IL (US)

Correspondence Address: HARNESS, DICKEY & PIERCE, P.L.C., P.O.BOX 8910, RESTON, VA, 20195, US

(21) Appl. No.: 11/507,467

(22) Filed: Aug. 22, 2006

(30) Foreign Application Priority Data
Aug. 23, 2005 (DE) 10 2005 039 887.1

(51) Int. Cl. H01M 8/00; H05G 1/10

(52) U.S. Cl. 429/12; 429/34; 378/101

(57) ABSTRACT

In order to make it easier to use solid state detectors, in particular mobile and wireless solid state detectors, a solid state detector for recording digital X-ray images is provided. The detector includes a physically integrated power supply device based on at least one fuel cell, for example a hydrogen/oxygen fuel cell. According to one refinement, the solid state detector has at least one tank for supplying fuel to the fuel cell.

### PRIORITY STATEMENT

The present application hereby claims priority under 35 U.S.C. §119 on German patent application number DE 10 2005 039 887.1 filed Aug. 23, 2005, the entire contents of which is hereby incorporated herein by reference.

### FIELD

The invention generally relates to a solid state detector for recording X-ray images.

### BACKGROUND

X-ray detectors in the form of solid state detectors are known in digital X-ray imaging for recording X-ray images of an object to be examined, in which X-radiation is converted by a scintillator or a direct converter layer to electrical charge and subsequently read out electronically by use of active readout matrices. The image data representing the examination results is subsequently transmitted to an evaluation and display device and further processed for image compilation (article “Flachbilddetektoren in der Röntgendiagnostik” [Flat image detectors in X-ray diagnosis] by M. Spahn, V. Heer, R. Freytag, published in the journal Radiologe 43, 2004, pages 340 to 350).

For example, DE 101 18 745 C2 discloses mobile wireless solid state detectors which have a power supply in the form of a battery or a rechargeable battery. Batteries are generally exhausted very quickly and must be replaced frequently. In order to charge the rechargeable battery, which is done via a plug connection or an inductive connection, the solid state detector has to be regularly and reliably fitted into a charging station and left there for a few hours.

### SUMMARY

At least one embodiment of the present invention simplifies and improves the usability of such solid state detectors, in particular mobile wireless solid state detectors.

Owing to the physically integrated power supply device based on at least one fuel cell, the solid state detector according to at least one embodiment of the invention, in particular a mobile and wireless solid state detector, is provided with a fully autonomized and position-independent power supply which is easy to use, long-lasting on account of the high energy density and life of the fuel cell, and can also be produced cost-effectively. The solid state detector according to at least one embodiment of the invention is independent both of cable connections and battery replacement, or locally and temporally constrained recharging. Fuel cells can also be integrated easily in solid state detectors on account of their flexible geometric dimensions.

According to one refinement of at least one embodiment of the invention, the fuel cell is a hydrogen/oxygen fuel cell. The fuel for such a fuel cell can be obtained easily and inexpensively; in the case of oxygen, for example, the surrounding air can simply be used. The solid state detector advantageously has at least one tank for supplying fuel to the fuel cell. In particular, one or more hydrogen tanks are provided for the advantageous hydrogen/oxygen fuel cell.

### BRIEF DESCRIPTION OF THE DRAWINGS

The invention and another advantageous refinement according to features of the dependent claims will be explained in detail below with reference to schematically illustrates example embodiments in the drawings, without thereby restricting the invention to these example embodiments:

FIG. 1 shows a plan view of a solid state detector according to an embodiment of the invention with integrated fuel cell and hydrogen tanks.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

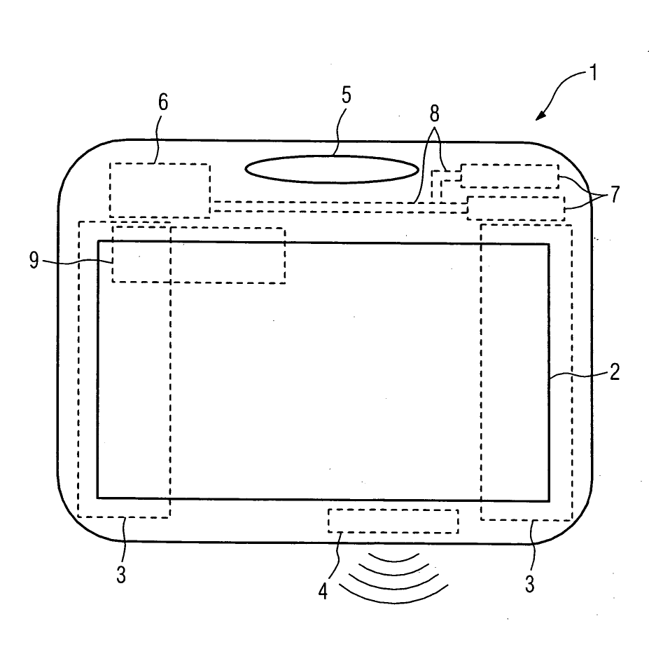

FIG. 1 shows a mobile and wireless solid state detector 1, fitted according to an embodiment of the invention with a fuel cell for the supply of power. The fuel cell is preferably a hydrogen/oxygen fuel cell 6, which is an electrochemical cell which converts the reaction energy of continuously supplied hydrogen and the oxidant oxygen to useful electrical energy.

The solid state detector 1 has, besides an active area 2, read-out and drive electronics 3 and a data transmission unit 4. The active area 2 in general has a scintillator or a direct converter for converting X-radiation striking the active surface 2 into electrical charge. The electrical charge is then read out electronically using an active matrix located below the converter in the direction of the X-radiation. The read-out and drive electronics 3 in this case drive the active matrix.

The solid state detector 1 is a mobile solid state detector which can be carried using a handle 5, for example. The solid state detector 1 can also be used without wires and its data transmission unit 4 is intended for wireless bidirectional data transmission, for example via radio or WLAN.

The hydrogen/oxygen fuel cell 6 is connected to two hydrogen tanks 7 via a plurality of connection lines 8 such that oxygen can be supplied to the fuel cell as necessary. Both the hydrogen supply and the oxygen supply from the surrounding air are regulated by power-supply regulation electronics 9. A plurality of fuel cells can also be provided for supplying power to the solid state detector 1. Advantageously it is possible to refill and/or replace the tank 7 for a continuous flexible power supply.

The solid state detector 1 may additionally have, besides a fuel cell, other power supplies, such as a battery or a rechargeable battery. It is correspondingly possible to choose between the different power supply options automatically or manually.

At least one embodiment of the invention can be briefly summarized as follows: in order to make it easier to use solid state detectors, in particular mobile and wireless solid state detectors, a solid state detector 1 for recording digital X-ray images is provided with a physically integrated power supply device based on at least one fuel cell, in particular a hydrogen/oxygen fuel cell 6. According to one refinement of the invention, the solid state detector 1 has at least one tank 7 for supplying fuel to the fuel cell.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A solid state detector for recording digital X-ray images, comprising a physically integrated power supply device including at least one fuel cell.

2. The solid state detector as claimed in claim 1, wherein the at least one fuel cell is in the form of a hydrogen/oxygen fuel cell.

3. The solid state detector as claimed in claim 1, wherein the solid state detector is in the form of a mobile solid state detector.

4. The solid state detector as claimed in claim 1, wherein the solid state detector is in the form of a wireless solid state detector.

5. The solid state detector as claimed in claim 1, wherein the solid state detector includes at least one tank for supplying fuel to the at least one fuel cell.

6. The solid state detector as claimed in claim 5, wherein the at least one tank is designed to be at least one of refillable and replaceable.

7. The solid state detector as claimed in claim 1, further comprising an active area, read-out and drive electronics and a data transmission unit.

8. The solid state detector as claimed in claim 1, wherein the solid state detector includes a plurality of tanks for supplying fuel to the at least one fuel cell.

9. The solid state detector as claimed in claim 8, wherein the plurality of tanks are designed to be at least one of refillable and replaceable.

10. The solid state detector as claimed in claim 5, wherein fuel supply is regulated by power-supply regulation electronics.

11. The solid state detector as claimed in claim 8, wherein fuel supply is regulated by power-supply regulation electronics.
